(19) United States
(12) Patent Application Publication
(10) Pub. No.: US 2008/0056450 A1
(43) Pub. Date: Mar. 6, 2008

(54) X-ray tubes and methods of making the same

(75) Inventors: Prasad Joshi, Pune (IN); Srinidhi Sampath, Bangalore (IN); Gwenael Lemarchand, Limours (FR); Isabelle Berangere Rouzou, Vanves (FR)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/514,417

(22) Filed: Sep. 1, 2006

(51) Int. Cl. H01J 35/00

(52) U.S. Cl. 378/132

(57) ABSTRACT

A rolling contact bearing assembly is provided. The bearing assembly includes an inner ring and an outer ring concentrically disposed about the inner ring. The bearing assembly further includes a plurality of rolling contact elements disposed between the inner and outer rings, where at least one of the inner ring, the outer ring and the rolling elements having a solid lubricant coating disposed thereon. The bearing assembly further includes a gallium-based cooling solution disposed between the inner and outer rings and in contact with the rolling contact elements.

### BACKGROUND

The invention relates generally to an X-ray tube. In particular, the invention relates to bearings used in X-ray tubes, and to arrangements designed to enhance heat dissipation in an X-ray tube and thereby to enhance the life of the bearings.

In X-ray tubes having rotating anodes, the heat of the shaft is conducted from and thus removed from the shaft through the shaft bearings. The heat is eventually conducted to the bearing housing through only very small surfaces of contact between races and balls of the bearings. This very small area of contact for thermal conduction may result in inefficient heat removal from the shaft. Inefficient heat escape from the shaft may, in turn, result in limiting the input power on the target, which is connected to the shaft, ultimately resulting in limiting output power of the X-rays and the continuous operation of the X-ray tube. Furthermore, disadvantageously, inefficient escape of the heat from the shaft may also result in elevated temperatures at the contact points or asperity contacts of the shaft and the bearings. Such heat can effectively reduce the expected useful life of the tube.

It has been proposed to use solid lubricants in such applications, at least to prolong the life of the bearings. However, the elevated temperatures at the asperity contacts may impair the capability of the solid lubricant to effectively lubricate the bearing components, seriously reducing the operating life of the bearings. It has also been proposed to use silver in X-ray tubes as a solid lubricant. When employed as a solid lubricant, silver can be effective at adding up to about 60 to 70 percent to the life of the bearings. However, silver lubricated bearings have high wear rates at elevated temperatures due to welding at asperity contacts. Occasionally, gallium may be employed as a lubricant, but due to its corrosive nature and low lubrication capability (film thickness), gallium as a lubricant results in excessive wear of the bearings.

Accordingly, there is a need for a suitable lubricant and a coolant for rotating anode assemblies in X-ray tubes that provide lubrication and also remove heat to maintain desirable temperatures around the anode.

### BRIEF DESCRIPTION

In accordance with one aspect of the present technique, a rolling contact bearing assembly is provided. The bearing assembly includes an inner ring and an outer ring concentrically disposed about the inner ring. The bearing assembly further includes a plurality of rolling contact elements disposed between the inner and outer rings, where at least one of the inner ring, the outer ring and the rolling elements has a solid lubricant coating disposed thereon. The bearing assembly further includes a gallium-based cooling solution disposed between the inner and outer rings and in contact with the rolling contact elements.

In accordance with another aspect of the present technique, a rotating anode assembly for use in an X-ray tube is provided. The rotating anode assembly includes a shaft configured to rotate the rotating anode assembly, a rolling contact bearing assembly disposed about the shaft. The rolling contact bearing assembly includes an inner ring, an outer ring disposed concentrically about the inner ring, a plurality of rolling contact elements disposed between the inner and outer rings, at least one of the inner ring, the outer ring or the rolling elements having a solid lubricant coating disposed thereon, and a cooling solution comprising gallium disposed between the inner and outer rings and in contact with the rolling contact elements.

In accordance with yet another aspect of the present technique, an X-ray tube for generating X-rays is provided. The X-ray tube includes a rotating anode, a shaft supporting the rotating anode, and an anti-friction bearing assembly supporting the shaft in rotation. The anti-friction bearing assembly includes a plurality of anti-friction elements disposed in a housing formed by inner and outer bearing rings, where at least one of the outer ring, the inner ring, or the plurality of anti-friction elements includes a lubricant coating disposed thereon. The bearing assembly further includes a thermal dissipation medium disposed between and in contact with the inner and outer rings, where the thermal dissipation medium comprises a gallium-based coolant.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional side view of an exemplary X-ray tube assembly according to certain embodiments of the present technique;

FIG. 2 is a cross sectional view of an exemplary anode assembly employing thermal compensation components and rolling contact bearings according to certain embodiments of the present technique;

FIG. 3 is a top view of a rolling contact bearing assembly employing a plurality of rolling contact elements disposed between the inner and outer rings according to certain embodiments of the present technique;

FIG. 4 is a cross sectional side view of a rolling contact element disposed between the inner and outer races of a bearing assembly according to certain embodiments of the present technique;

FIG. 5 is a cross sectional side view of an angular contact bearing according to certain embodiments of the present technique; and

FIG. 6 is a diagrammatical illustration of a thermal dissipation path in an anode assembly according to certain embodiments of the present technique.

### DETAILED DESCRIPTION

The present technique is generally directed to X-ray tubes. Particularly, the invention relates to bearings used in X-ray tubes, and to arrangements designed to enhance heat dissipation in X-ray tubes. X-ray tubes may be used in variety of applications, such as in imaging systems, particularly for medical imaging and baggage or package screening. Though the present discussion provides examples in a medical imaging context, one of ordinary skill in the art will readily comprehend that the application of these X-ray tubes in other settings, including non-medical imaging contexts, such as for security screening, is well within the scope of the present technique.

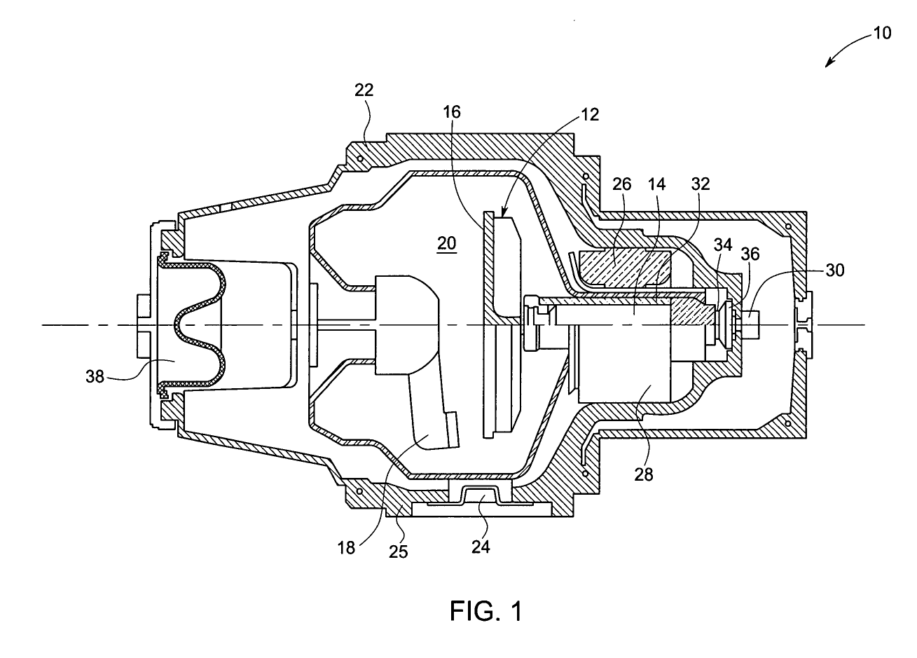

Referring now to FIG. 1, a rotating anode X-ray tube 10 is depicted. The X-ray tube 10 may be employed in medical diagnostic systems for providing a focused beam of X-ray radiation. The tube 10 includes a rotating anode assembly 12. The anode assembly 12 includes a cylindrical body or shaft 14. The shaft 14 is coupled to the target 16 on one end, and is coupled to an evacuated chamber 20 at the opposite end. The tube 10 further includes a cathode 18. The anode assembly 12 and the cathode 18 may be operated in the chamber 20. A glass envelope 22 typically defines the evacuated chamber 20. The cathode 18 supplies and focuses an electron beam onto the target 16. Electrical current may be supplied to the cathode 18 by means of a filament (not shown). When the electron beam emanating from the cathode 18 strikes the target 16 of the rotating anode assembly 12, a portion of the beam is converted to X-rays, which are emitted from the surface of the target 16. X-rays may exit the tube 10 through a port window 24 of the envelope 22. The port window 24 may also have a corresponding counterpart (not shown) on the surrounding cooling oil enclosure 25, which surrounds the envelope 22.

Further, a motor 26 may be employed to rotate the shaft 14 of the anode assembly 12. The motor 26 may include, for example, an induction motor. The induction motor may include a stator (not shown), which may have driving coils disposed outside the envelope 22. Further, the motor 26 may also include a rotor 28, which may be disposed inside the envelope 22 and in operative association with the shaft 14 of the rotating anode assembly 12.

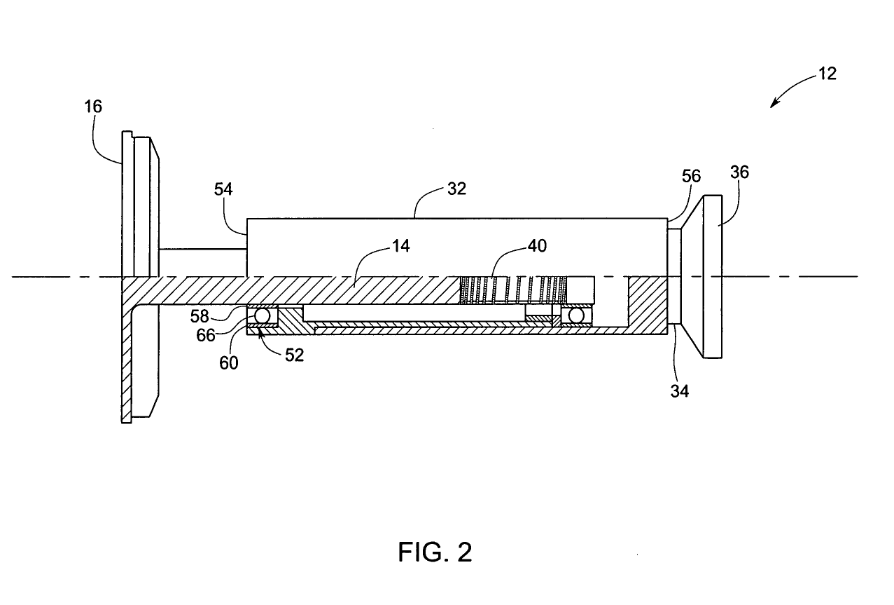

In the illustrated embodiment, the shaft 14 is disposed in an anode housing or cartridge 32. The anode housing 32 has cylindrical walls. The motor 26 is secured to the walls of the anode housing 32. As will be described in detail below with regard to FIG. 2, a rolling contact bearing assembly (not shown) is employed in the anode housing 32 around the shaft 14 to facilitate the rotation of the shaft 14.

When the motor 26 is energized, the driving coils induce magnetic fields, which cause the bearing member to rotate relative to a rotor support 34. The rotor support 34 is typically cylindrical in shape and may be connected, at a rearward end, by a mounting assembly 36 with the envelope 22. A portion 30 of the mounting assembly 36 extends out of the envelope 16 to rigidly support the rotor 34. The tube 10 further includes an oil expansion bellows 38 to house oil in order to provide thermal cooling to the tube 10.

Turning now to FIG. 2, a cross sectional view of the rotating anode assembly 12 of FIG. 1 is illustrated. The rotating anode assembly 12 employs a thermal compensation component 40 to minimize the temperature effect on the rotating anode assembly 12. In the presently contemplated embodiment, the thermal compensation component 40, disposed inside the anode housing 32, includes preloaded springs. The preloaded springs may be initially compressed based on the expected thermal expansion of the shaft 14 during operation of the X-ray tube 10. Subsequently, the load of the springs may be reduced to compensate for the thermal expansion of the shaft 14. In one embodiment, the housing 32 may include a spacer 42 disposed between the shaft 14 and the anode housing 32.

Further, the rotating anode assembly 12 includes one or more rolling contact bearing assemblies disposed about the shaft 14. In the presently contemplated embodiment, the shaft 14 employs two rolling contact bearing assemblies 50 and 52. Although not illustrated, in some embodiments, the shaft 14 may employ single rolling contact bearing assembly. The rolling contact bearing assemblies 50 and 52 are disposed at the front end 54 and the back end 56, respectively of the shaft 14. In one embodiment, the two rolling contact bearing assemblies 50 and 52 may be employed relatively closer to each other. For example, both the rolling contact bearing assemblies 50 and 52 may be employed either on the front end 54 or the back end 56 of the shaft 14.

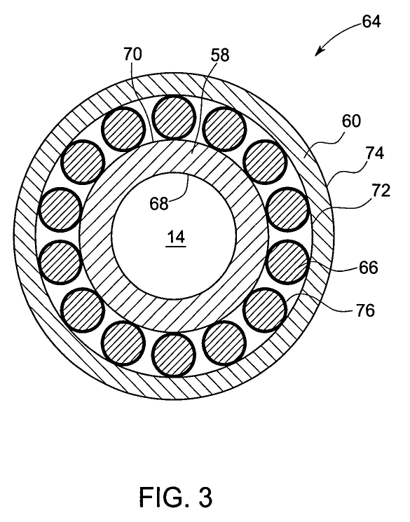

Each of the roller contact bearing assemblies 50 and 52 includes an inner ring 58 and an outer ring 60. As will be described in detail below, the inner and outer rings 58 and 60 include races between which a plurality of rolling contact elements is disposed. Further, as described in detail below with regard to FIG. 3, the one or more of the inner ring 58, the outer ring 60, or the plurality of rolling contact elements includes a lubricant coating disposed thereon (not shown). Also, the housing 32 includes a thermal dissipation medium disposed between the inner and outer rings 58 and 60 and in contact with the plurality of rolling contact elements. In one embodiment, the thermal dissipation medium includes a gallium-based cooling solution.

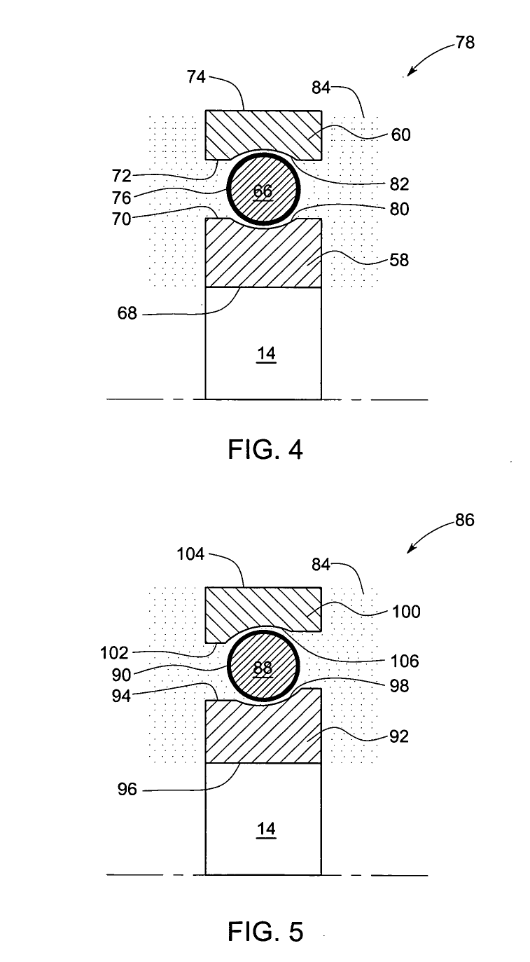

FIG. 3 illustrates a top view of a rolling contact bearing assembly 64 employing a plurality of rolling contact elements 66 disposed between the inner ring 58 and the outer ring 60. The inner ring 58 and the outer ring 60 are disposed concentrically. Further, the inner ring 58 includes inner and outer diameters 68 and 70, respectively, and the outer ring 60 includes inner and outer diameters 72 and 74, respectively. As will be described in detail below with regard to FIG. 4, the inner and outer rings 58 and 60 include races on one of these inner and outer diameters, between which the plurality of rolling contact elements 66 may be disposed. In the presently contemplated embodiment, the plurality of rolling contact elements 66 include a solid lubricant coating 76 disposed thereon. The solid lubricant coating 76 provides lubrication to the plurality of rolling contact elements 66 while in motion inside the race. In one embodiment, the coefficient of friction of the solid lubrication coating 76 is in a range from about 0.02 to about 0.3.

FIG. 4 illustrates a cross sectional view of a portion 78 of the rolling contact bearing assembly 64 of FIG. 3. The portion 78 includes one of the rolling contact elements 66 disposed between the inner and outer rings 58 and 60. In the presently contemplated embodiment, the outer diameter 70 of the inner ring 58 forms an inner race 80. Similarly, the inner diameter 72 of the outer ring 60 forms an outer race 82. As illustrated, the inner and outer races 80 and 82 are spaced from one another to receive the rolling contact element 66.

Further, as noted above, the rolling contact element 66 includes a solid lubricant coating 76 disposed on the surface of the rolling contact elements 66. In certain embodiments, the solid lubricant coating 76 may be present on the elements 66 in the form of a thin film. In some embodiments, the solid lubricant coating 76 may act as a lubricant between elements 66. During operation of the X-ray tube 10, contact between the elements 66 and the races 80 and 82, and any contact between the elements 66 is lubricated by the lubricant coating to reduce the wear in the elements 66 and races. As will be appreciated, in the absence of lubrication at the contact points, the races 80 and 82, and elements 66 may experience wear at the contact points due to high sliding velocities created due to high rotating speeds of the shaft 14 (FIG. 1). In one embodiment, the shaft 14 may rotate at a frequency of about 140 Hertz and more.

In certain embodiments, the elements 66 may include two or more solid lubricant coatings. These solid lubricant coatings, such as solid lubricant coatings 76 may be chemically resistive. For example, the solid lubricant coatings 76 may be chemically resistive to stainless steel and gallium-based cooling solutions 84. As will be appreciated, the inner and outer rings 58 and 60 may typically be made of stainless steel. In these embodiments, the solid lubricant coatings 76 may protect elements 66 from the chemical attack of the gallium-based cooling solution 84 and the stainless steel material of the inner and outer rings 58 and 60. In one embodiment, the races 80 and 82 and the outer rings 58 and 60 may be coated with lubricant coatings 76. In an exemplary embodiment, deposition techniques, such as electroplating, chemical vapor deposition, or physical vapor deposition, may be employed to coat the elements 66 with the solid lubricant coating 76. The thickness of the lubricant coatings 76 may be in a range of from about 0.01 microns to about 5 microns.

In some embodiments, the solid lubricant coating 76 may include molybdenum, tantalum, vanadium, cobalt, or a combination thereof. In other embodiments, the solid lubricant coating 76 may include nitrides of titanium, chromium, tantalum, vanadium, boron, titanium-aluminum, titanium-carbon, aluminum-chromium, or a combination thereof. For example, the solid lubricant coating 76 may include hexagonal boron nitride. In one embodiment, the solid lubricant coating 76 may include di-chalcogenides of molybdenum, niobium, tungsten, or a combination thereof. The di-chalcogenides may include di-sulphides, di-selenides, di-tellurides, or a combination thereof. In an exemplary embodiment, the di-chalcogenides may be doped by titanium. As will be described in detail below, in some embodiments, the solid lubricant coatings 76 may include a combination of two or more such coatings.

As mentioned above, the solid lubricant coatings 76 may include a combination of two or more such coatings. For example, the solid lubricant coating 76 may include a molybdenum disulphide coating having a silver coating disposed thereon. This may be done to protect the inner coating from chemical attack by the gallium-based cooling solution 84. In one embodiment, the solid lubricant coating is chemically resistant to the gallium-based cooling solution 84. The thickness of the solid lubricant coating 76 may be in a range from about 100 nanometers to about 1500 nanometers, for example.

Although not illustrated, in some embodiments, the inner ring 58 may be integral with the shaft 14. For example, the inner ring 58 along with the races 80 may be machined on the shaft 14. Further, in some embodiments, the anode assembly 12 may follow inner rotation, where the inner ring 58 rotates along with the shaft 14. Whereas, in other embodiments, the anode assembly 14 may follow outer rotation where the inner ring 58 may be stationary. In these embodiments, the target 16 rotates on the outer ring 60 and the shaft 14. Further, the anode housing 32 rotates along with the outer ring 60 and the shaft 14.

In some embodiments, the races 80 and 82 may be coated with the solid lubricant coating 76, thereby creating a surface of lubricant to allow a low friction interface between the rolling elements 66 and the inner and outer races 80 and 82, during operation.

During operation, when an electron beam is directed from a cathode 18 (FIG. 1) to the target 16, intense heat is generated in the X-ray tube. Most of the energy of the incident electron beam is transformed into heat, causing a temperature rise in the target 16. As will be appreciated, the overall temperature in a rotating anode X-ray tube, such as X-ray tube 10 may be more than about 500° C. The inefficient removal of the heat of the shaft 14 may result in problems in cooling the target 16. As a result, the effectiveness of target 16 in the production of X-rays and the continuous operation of the X-ray tube 10 can be reduced. Furthermore, due to inefficient removal of the heat of the shaft 14, the shaft 14 is disadvantageously maintained at elevated temperatures. The elevated temperatures of the shaft 14, in turn, increase the temperature of the bearing rings and the rolling contact elements, as well as the lubricant coating 76, which are in contact with the shaft 14. This in turn, can reduce the lubricating effect of the solid lubricant coating 76, and reduce the operating life of the bearing components. Accordingly, it is desirable to have a combination of a lubricant coating 76 and a cooling solution for cooling the bearing rings and the rolling contact elements.

In certain embodiments of the present technique, the heat generated in the X-ray tube may be effectively discharged outwardly of the X-ray tube 10 by, for example, a gallium-based cooling solution. For this purpose, a gallium-based cooling solution 84 may be disposed between the inner and outer rings 58 and 60. The gallium-based cooling solution 84 may be employed to reduce the temperature within the bearings, particularly at the contact points between the rolling contact elements 66 and the races 80 and 82. Consequently, the gallium-based cooling solution 84 may prevent welding between the elements 66 coated with the solid lubricant coating 76, and the races 80 and 82 and reduce excessive wear at high temperatures, thereby improving the overall life of the bearing components. Moreover, due to the cooling effect provided by the gallium-based cooling solution 84, the X-ray tube 10 runs at lower temperature. Also, the damping provided by the gallium-based cooling solution 84, results in the noise reduction of about 10 decibels to about 15 decibels.

In certain embodiments, the gallium-based cooling solution 84 may include an alloy of gallium, indium, tin, or a combination thereof. The melting point of the gallium-based cooling solution 84 may be such that the gallium-based cooling solution 84 remains in a molten state at the operating temperatures of the X-ray tube, such as X-ray tube 10 (FIG. 1). In an exemplary embodiment, a melting point of the gallium-based cooling solution may be in a range from about 5° C. to about 200° C. In one embodiment, the melting point of the gallium-based cooling solution may be in a range from about 5° C. to about 60° C. In another embodiment, the melting point of the gallium-based cooling solution may be in a range from about 60° C. to about 110° C.

In addition, when employing the gallium-based cooling solution 84 in the X-ray tube 10, the gallium-based cooling solution 84 may be introduced directly in the anode housing 32. In some embodiments, the housing 32 may be partially filled with the gallium-based cooling solution 84. In these embodiments, the gallium based cooling solution 84 may be retained between the inner and outer rings 58 and 60 mainly due to hydrodynamic forces experienced by the gallium-based cooling solution 84 during the operation of the X-ray tube 10. In other words, as the rolling contact elements 66 start moving, a thin film is formed on the elements 66 due to squeezing action between the races 80 and 82. This film may be useful to remove heat from the contact areas between the rolling contact element 66 and one or both of the races 80 and 82.

In other embodiments, the housing 32 may be completely filled with the gallium-based cooling solution 84. In these embodiments, the gallium-based cooling solution 84 may be in contact with the rolling contact elements 66 during and after the operation of the X-ray tube 10.

Referring now to FIG. 5, in certain embodiments, the rolling contact bearing assembly, such as assembly 86, may include radial contact ball bearings or an angular contact ball bearing 88 having a solid lubricant coating 90 disposed thereon. The rolling contact bearing assembly 86 includes inner and outer rings 92 and 100. The inner ring 92 has inner and outer diameters 94 and 96. The inner ring 92 forms a race 98 formed at the outer diameter 96. Similarly, the outer ring 100 has inner and outer diameters 102 and 104. The inner diameter 102 of the outer ring 100 forms a race 106. During operation of the tube 10, the radial contact ball bearings 88 are in contact with the inner and outer rings 92 and 100 between the races 98 and 104.

In certain embodiments, the angular contact ball bearings 88 are configured to support combined radial and thrust loads (caused by rotation of the shaft 14). The magnitude of the thrust loads supported by the angular contact ball bearings 88 may depend on the contact angle of the radial contact ball bearings 88 and the races 98 and 106. In one exemplary embodiment, the radial contact ball bearings 88 having large contact angles may support heavier thrust loads. Accordingly, the radial contact ball bearings 88 may be suitable for applications including high speed of the shaft 14.

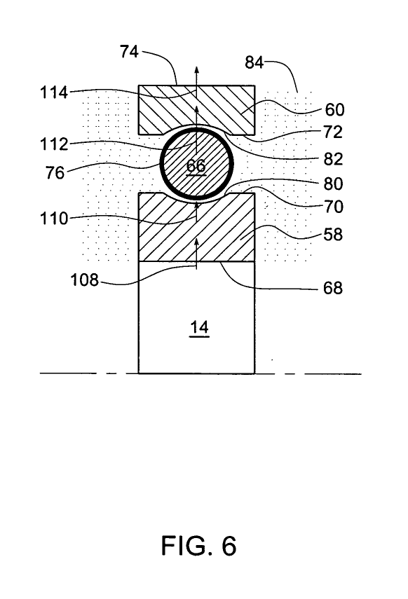

FIG. 6 illustrates an exemplary thermal conduction path in the rotating X-ray tube, such as X-ray tube 10. The gallium-based cooling solution 84 acts as a coolant. As indicated by an arrow 108, the heat may be transferred from the shaft 14 to the inner ring 58 by conduction. The heat from the inner ring 58 may be then conducted from the inner ring 58 to the rolling contact elements 66 via the solid lubricant coating 76 and the gallium-based cooling solution 84. Subsequently, the heat from the rolling contact elements 66 may be then transferred to the outer ring 60 via the solid lubricant coating 76 and the gallium-based cooling solution 84. The heat from the outer ring 60 may then be dissipated via the gallium-based cooling solution 84. Although, not illustrated, the cooling path may be the other way (from outward to inward) in the case of an outer rotation arrangement of the anode assembly 12.

The gallium-based cooling solution 84 may also directly contact the inner and outer rings 80 and 82 to transfer heat between the rings 80 and 82. The heat is transferred from the inner ring 80 to the outer ring 82 via the rolling contact elements 66 as well as through the cooling solution directly. In one embodiment, the gallium-based cooling solution reduces the temperature at the contact zones by about 100° C. to about 150° C. Advantageously, the gallium-based cooling solution 84 facilitates reduction of overall temperature inside the X-ray tube 10 (FIG. 1). Additionally, the gallium-based cooling solution 84 helps in improving the life of the bearing races and the rolling contact elements. For example, the gallium-based cooling solution 84 reduces the temperature at the asperity contact points in the elements 66 coated with solid lubricant coating 76, thereby reducing the wear rate of the races and bearing elements. Further, the gallium-based cooling solution 84 may also provide lubrication to the elements 66 to bring down the wear of the solid lubricant coating 76, which may otherwise have been present due to absence of any lubrication between element-to-element contacts, thereby improving the life of the elements 66 by employing a combination of the solid lubricant coating 76 and the gallium-based cooling solution 84. Also, the gallium-based cooling solution 84 may also help in maintaining lower temperatures around the elements 66, thereby reducing the risk of the elements 66 or the solid lubricant coating 76 undergoing wear or even welding during operation. It should be noted that, although certain existing X-ray tubes have attempted to employ solid lubricants, while others have attempted to use gallium-based lubrication, to the knowledge of the inventors, these have never been used in combination. The inventors have found that, unexpectedly, certain coatings used in the present invention can serve both as lubricants and as protective barriers from the corrosive effects of liquid lubricant systems. The combination therefore permits the use of such liquid lubricant systems to effectively transfer much more heat through the bearings without the detrimental effects of corrosion on the bearing components.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A rolling contact bearing assembly, comprising:
an inner ring;
an outer ring disposed concentrically about the inner ring;
a plurality of rolling contact elements disposed between the inner and outer rings, at least one of the inner ring, the outer ring and the rolling elements having a solid lubricant coating disposed thereon; and
a gallium-based cooling solution disposed between the inner and outer rings and in contact with the rolling contact elements.

2. The rolling contact bearing assembly of claim 1, the gallium-based cooling solution comprising an alloy of indium, tin, or a combination thereof.

3. The rolling contact bearing assembly of claim 1, wherein the solid lubricant coating comprises two or more coatings.

4. The rolling contact bearing assembly of claim 1, wherein the solid lubricant coating is chemically resistant to the gallium-based cooling solution.

5. The rolling contact bearing assembly of claim 1, the solid lubricant coating comprising molybdenum, tantalum, vanadium, cobalt, or a combination thereof.

6. The rolling contact bearing assembly of claim 1, the solid lubricant coating comprising nitrides of titanium, chromium, tantalum, vanadium, boron, titanium-aluminum, titanium-carbon, aluminum-chromium, or a combination thereof.

7. The rolling contact bearing assembly of claim 1, the solid lubricant coating comprising di-chalcogenides of molybdenum, niobium, tungsten, or a combination thereof.

8. The rolling contact bearing assembly of claim 8, wherein the di-chalcogenides are doped by titanium.

9. The rolling contact bearing assembly of claim 1, wherein a thickness of the solid lubricant coating is in a range from about 100 nanometers to about 1500 nanometers.

10. The rolling contact bearing assembly of claim 1, wherein the gallium-based cooling solution contacts the inner and outer rings to transfer heat between the rings.

11. The rolling contact bearing assembly of claim 1, wherein the inner and outer rings have a temperature difference in a range from about 100° C. to about 150° C.

12. The rolling contact bearing assembly of claim 1, wherein the bearing comprises a radial contact ball bearing or an angular contact ball bearing.

13. A rotating anode assembly for use in an X-ray tube, comprising:
a shaft configured to rotate the rotating anode assembly;
a rolling contact bearing assembly disposed about the shaft, the rolling contact bearing assembly comprising:
an inner ring;
an outer ring disposed concentrically about the inner ring;
a plurality of rolling contact elements disposed between the inner and outer rings, at least one of the inner ring, the outer ring or the rolling elements having a solid lubricant coating disposed thereon; and
a cooling solution comprising gallium disposed between inner and outer rings and in contact with the rolling contact elements.

14. The anode assembly of claim 13, wherein the coefficient of friction of the solid lubrication coating is in a range from about 0.02 to about 0.3.

15. The anode assembly of claim 13, wherein the cooling solution comprises gallium.

16. An X-ray tube for generating X-rays, the X-ray tube comprising:
a rotating anode;
a shaft supporting the anode; and
an anti-friction bearing assembly supporting the shaft in rotation, the anti-friction bearing assembly comprising:
a plurality of anti-friction elements disposed in an housing formed by inner and outer bearing rings, wherein at least one of the outer ring, the inner ring, or the plurality of anti-friction elements comprises a lubricant coating disposed thereon; and
a thermal dissipation medium disposed between and in contact with the inner and outer rings, wherein the thermal dissipation medium comprises a gallium-based coolant.

17. The X-ray tube of claim 16, comprising two anti-friction bearing assemblies disposed at a distance from one another along the shaft.

18. The X-ray tube of claim 16, further comprising a thermal compensation element disposed about the shaft.

19. The X-ray tube of claim 16, wherein the lubricant coating comprises two or more coatings.

20. The X-ray tube of claim 16, wherein the lubricant coating is chemically resistant to the gallium-based cooling solution.
